(19) United States
(12) Patent Application Publication
(10) Pub. No.: US 2006/0148569 A1
(43) Pub. Date: Jul. 6, 2006

(54) Methods and apparatus for a portable toy video/audio visual program player device - "silicon movies" played on portable computing devices such as pda (personal digital assistants) and other "palm" type, hand-held devices

(76) Inventor: Stephen C. Beck, Berkeley, CA (US)

Correspondence Address: BIRCH STEWART KOLASCH & BIRCH, PO BOX 747, FALLS CHURCH, VA, 22040-0747, US

(21) Appl. No.: 10/476,077

(22) PCT Filed: May 2, 2003
(86) PCT No.: PCT/US03/13863

§ 371 Date: Oct. 23, 2003

Related U.S. Application Data
(60) Provisional application No. 60/377,372, filed on May 2, 2002.

(51) Int. Cl. A63F 13/00

(52) U.S. Cl. 463/43

(57) ABSTRACT

A portable audio/visual program player comprising a video display, electrical-audio transducer, a central processing unit and associated logic and memory circuits. The portable audio/visual player is able to play pre-recorded programs from a memory device, which includes compress digital audio and video program information and a decoder program. The digital compression method comprises a series of compression methods to greatly reduce the amount of digital data. The data compression method is particularly suitable for motion video comprising cartoons and similar images, but is also suitable for other applications.

This application claims priority of copending U.S. Provisional Patent Application No. 60/377,372, filed May 2, 2002, which in its entirety is incorporated by reference herein.

### FIELD OF THE INVENTION

This invention relates generally to toys and games, and more particularly, to devices capable of displaying prerecorded audio visual information and games utilizing such toys, games utilizing such toys, and methods of compressing digitized audio/visual information for wired and wireless communications systems.

There are presently available portable video player devices that permit the user to watch prerecorded television programs, movies, animated cartoons, and other content. These devices are generally manufactured for adults and utilize a memory device such as a prerecorded videotape or DVD on which the audio/video information is stored. These devices presently on the market are not generally directed to children and are relatively expensive. The invention is in one embodiment a low cost, portable, hand-held and/or wearable audio/visual program player. The invention also includes combining game play with the audio/visual program player and the playing of interactive video games on the audio/visual program player.

The invention enables children and other users to watch prerecorded television programs, movies, cartoons, and other audio/visual content on a small, portable hand-held or wearable audio/visual program player at a very low cost compared to adult or professional products presently on the market.

The invention also includes a plug-in device for video game playing units such as Nintendo Game Boy Advance (“GBA”), Game Boy Color (“GBC”), Nokia N-Gauge Wireless Telephone and gaming system, personal digital assistants and wireless communications devices such as color cellular telephone handsets, and other similar devices, which will enable the user to watch and listen to prerecorded audio/visual programs on the video screen, utilizing the audio speaker of the video game playing unit. Additionally, the invention is capable of utilizing portable computing devices, such as personal digital assistants (“PDA”), electronic digital cameras, and similar devices having a video display screen for watching a prerecorded audio/visual program.

The invention also includes in one embodiment a unique and novel method for compressing digitized audio/video information and decompressing said information for playback viewing.

### PRIOR ART DISCUSSION

From the foregoing discussion, important aspects of the technology use in the field of the invention remain amiable to useful refinements.

Various compression techniques for reducing the quantity of digital data are presently known. Digital compression techniques such as Run Length Encoding (“RLE”) compression, Adaptive Differential Pulse Code Modulation (“ADPCM”) compression, LZSS compression, color quantization and vector quantization are presently known and utilized. In RLE, sequences of the same data values within a file are replaced by a count number and a single value. For example, if the string of data to be compressed is ABBBB, the compressed file under RLE could look like this: A*5b. In such a compression technique, repetitive strings of data are replaced by a control character (such as *) followed by the number of repeated characters in the repetitive character itself. The control character is not fixed, it can differ from implementation to implementation. RLE is easy to implement and does not require relatively high processing capability. RLE is only efficient with files that contain large amounts of repetitive data. As will be described in more detail herein below, certain types of data (for example, certain styles of cartoon animation) contain much repetitive data and thus are good candidates for RLE compression.

Adaptive differential pulse code modulation (“ADPCM”) is a speech compression method known to those in the art of audio digital data compression. The ADPCM compression method assumes that the neighboring audio samples are similar to each other. Instead of representing each sample independently as in pulse code modulation (PCM), ADPCM computes the difference between each audio sample and its predicted value and produces the PCM value of the differential. If the prediction is accurate, then the difference between the real and predicted speech samples will have a lower variance than the real speech samples, and will be accurately quantized with fewer bits than would be needed to quantize the original speech samples. At the decoder, the quantized difference signal is added to the predicted signal to give the reconstructed speech signal.

LZSS compression uses a dictionary-based compression scheme. LZSS uses previously seen text (or sequences) as a dictionary and replaces phrases in the input text with pointers into the dictionary to achieve compression. LZSS compression is highly asymmetrical. The compression routine is relatively complicated and requires a relatively large amount of work. However, the decompression/expansion code is extremely simple and may be accomplished quickly and with a relatively small level of digital processing capability, sometimes quantified by computer engineers as the number of instructions per second executed by the computer. The term “millions of instructions per second” is sometimes referred to as MIPS in this context.

Color quantization is used when the color information of an image is to be reduced. The most common situation is when a color image having, for example, 24 bit color, is transformed into an image having lower color quality such as an 8 bit color image. This technique is lossy as the image produced contains less color information than the original data image, which was compressed. Loss of color information is generally less noticeable to the viewer than spatial loss up to a level when the number of colors represented by the compressed data become more noticeable.

Vector quantization (VQ) is a lossy data compression method. VQ is an approximator. The idea is similar to that of “rounding off”. For example, a one-dimensional example may be viewed as a line beginning at zero with one inch segments marked from 0 to 10 inches. It will be understood that there are an infinite number of numbers, which may be represented on the line between 0 and 10. Using VQ as a technique to compress the data, each one inch segment is reduced to its midpoint (i.e., 0.5, 1.5, 2.5, . . . 8.5, 9.5). If a number falls within the segment 2-3, it is replaced by the number 2.5. Similarly, if a number is within the segment 6 to 7, it is replaced by the number 6.5. Thus, the infinitely variable list of numbers between 0 and 10 in a dataset are approximated by the 10 numbers: 0.5, 1.5, 2.5, . . . 8.5, 9.5. It will be understood that while the above example is given for one dimension, similar examples may be given for n dimensions. Accordingly, the original data set is approximated in VQ compression.

### SUMMARY OF THE DISCLOSURE

The present invention introduces many refinements and improvements over the present state of the art. In the preferred embodiments, the present invention has several aspects or facets that can be used independently, although they are preferably employed together to optimize their benefits.

In a preferred embodiment of its first facet or aspect, the invention is a portable audio/visual program player capable of playing audio/visual programs from a memory device. In a preferred embodiment, the audio/visual program player has a display screen such as a LCD, CRT or other video display device. The invention is capable of using prerecorded programmed memory devices such as audio tape cassettes, audio CDs, optical memory discs, semiconductor read-only memories or flash memories, holographic memories, nanotechnology memory devices, which could use organic molecules for read only memory at very high density, and other high density memory devices. The invention is also capable of operation from DC power sources, such as batteries, but also may be powered by means of the standard voltage present in the home or office.

In another preferred embodiment, the invention comprises a plug-in device, which is mateable with a video game unit such as the GBA or similar device. The plug-in device comprises a memory device such as enumerated above. In this embodiment, the audio/visual presentation is presented by means of the display screen and audio speaker in the GBA or similar device.

In a preferred embodiment of the invention, the information in the storage media comprises a control program, audio data, and video data. The control program provides the necessary program for enabling the Central Processing Unit of the player to process and present the audio and video information.

In another embodiment of the invention, a master player unit has digital processing and display capability, and is capable of receiving and interacting with a memory device. The master player unit is capable of receiving digital information from the memory device and converting such digital information into an audio/visual presentation for the user.

In another embodiment of the invention, compression techniques are used to vastly reduce the number of bits of digital information representing the audio and visual information stored in the memory devices used by the invention to hold the content data. Decompression techniques are used to retrieve (on a lossly and/or lossless basis) the precompressed digital information.

In a preferred embodiment of the invention, these compression and decompression techniques are asymmetrical, that is, the amount of time and computational digital processing power needed to compress the original data set exceed the time and computational digital processing power necessary to decompress the compressed data set. As will be appreciated, the initial compression of a prerecorded program need occur only once and may be accomplished through the use of high capacity digital processing equipment. The decompression of the compressed data must be accomplished quickly and with a low cost, lower capacity digital unit, so that the cost of the improved audio/video player remained relatively low.

Another independent facet or aspect of the invention is utilization of the portable audio/video player in games. In a preferred embodiment of this independent facet or aspect, the invention is an interactive audio/video game utilizable in playing games and other entertainment activities.

In another embodiment of the invention, motion video and audio content can be combined with and played with the interactive game as a portion of it. For example, a teaching game could present playback of audio/visual content of photographs, films and videos of cartoon shows or live action actors, animals, and scenes from real life that are blended within the game play pattern.

### BRIEF DESCRIPTION OF THE DRAWINGS

The drawings are schematic and not necessarily to scale.

FIG. 1 is a diagrammatic view of a preferred embodiment of the portable audio/visual program player.

FIG. 2 is a second embodiment of the invention comprising a hand-held video game unit.

FIG. 3a is a block diagram of a plug-in unit of one embodiment of the invention.

FIG. 3b is a block diagram of another plug-in unit of another embodiment of the invention.

FIG. 3c is a block diagram of a booster-card of another embodiment of the invention.

FIG. 3d is a block diagram of an alternative booster-card of another alternative embodiment of the invention.

FIG. 4 is a block diagram of an embodiment of the encoding method of a preferred embodiment of the invention.

FIG. 5 is a diagram of a memory containing a compressed audio file, compressed video file, and other files/programs in an embodiment of the invention.

FIG. 6 is a block diagram of the audio encoding process of an embodiment of the invention.

FIGS. 7a and 7b are block diagrams of the video encoding process of an embodiment of the invention.

FIG. 8 is a diagram depicting pixel replication in an embodiment of the invention.

### DETAILED DESCRIPTION OF THE PREFERRED EMBODIMENTS

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those having ordinary skill in the art from this detailed description.

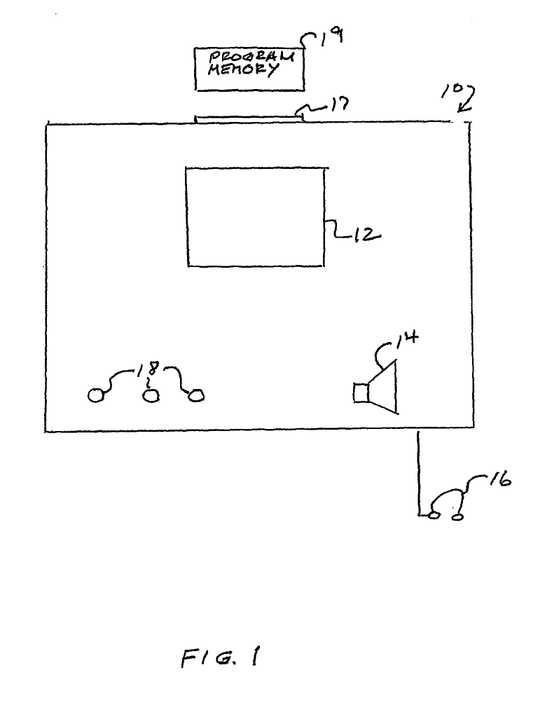

FIG. 1 discloses one preferred embodiment of the portable audio/visual program carrier 10. The audio/visual display device 10 is a portable light weight device, capable of processing digital data and converting it into video and audio information. The digital data may be stored on a variety of media. For example, the digital data may be stored on magnetic tape or disk, compact disc, DVD, or in a semiconductor memory, holographic memory or other read/write non-volatile memory, such as a flash memory card.

The display screen 12 in a preferred embodiment is a small liquid crystal display, which may be either black and white, monochrome, or color. Additionally, it will be understood that the display screen may also be another type of screen such as a CRT or active or passive matrix LCD display, or even an organic light emitting diode (“OLED”) display screen. The imaging device may also be an eye mount or eye projection screen. It will be understood that one of the objectives of the invention is to provide a low cost audio/visual display and, accordingly, lower cost displays are generally preferable.

The audio/visual display may in an embodiment be part of a hand-held game unit, such as a GBA or other similar unit presently on the market. Such a configuration is described in detail herein below.

The audio/visual player may utilize a speaker 14 to produce sound. However, it will also be understood that a audio headset or earphones 16 may be operably connected to the audio/visual player so that the sound is produced at the earphones. In such an embodiment, persons in the vicinity of the audio/visual player will not be disturbed by the audio of the programming. The audio/video player includes controls 18 for controlling the audio level, brightness, contrast, start/stop, pause and other functions of the audio/video player. The audio/video player also has a port 17 for receiving a program memory 19 containing audio/video digital data. The audio/video digital data is described in detail below. The program memory 19 may be of a type which is also identified herein below.

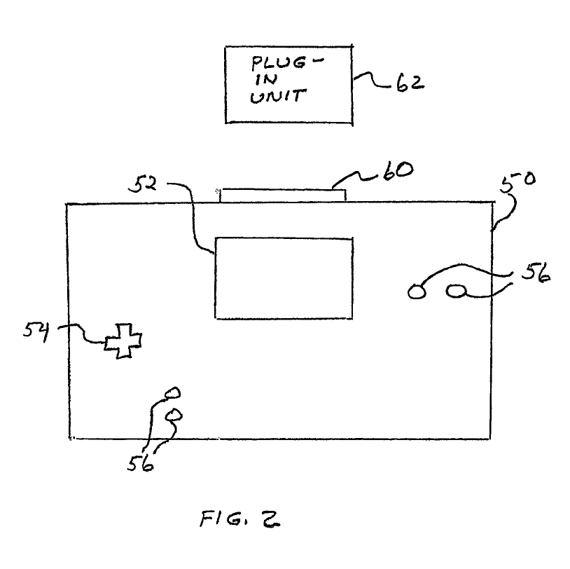

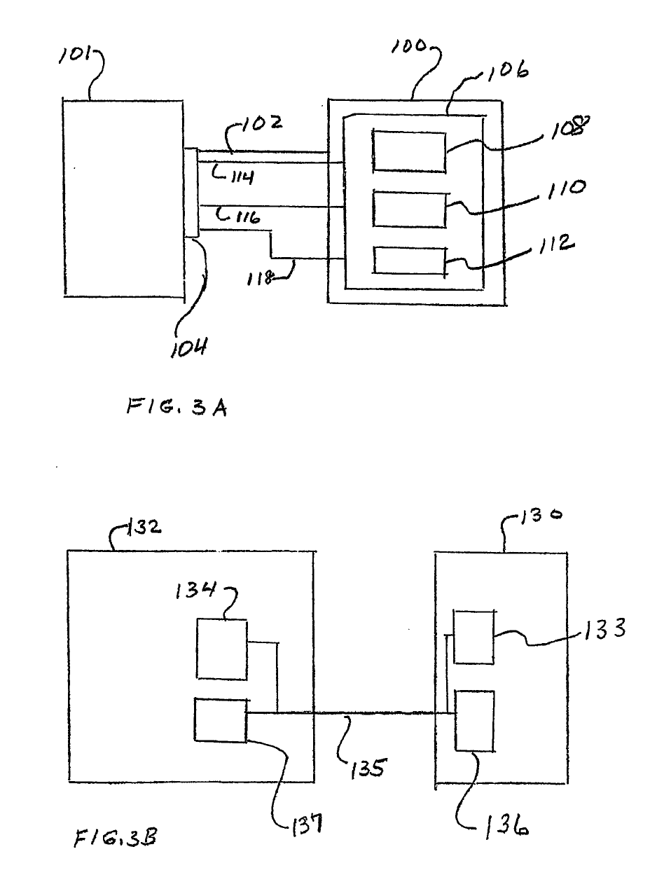

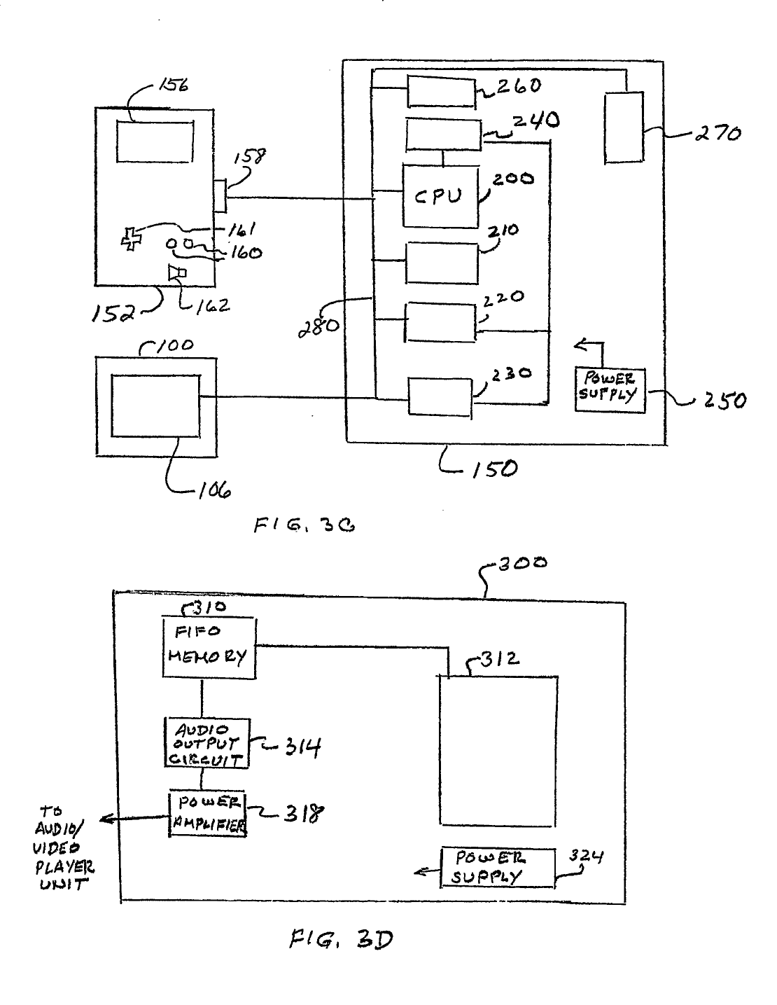

Next referring to FIG. 2, there is disclosed in schematic form an embodiment of the invention, which utilizes a hand-held video game unit 50. The video game unit 50 has a display screen 52 and controls 54 and 56. The video game unit 50 may be a video game unit such as a Game Boy Advance, etc. The video display screen 52 is capable of displaying an image. Controls 54 and 56 are utilized to adjust the video display and the audio level. The video game unit also has an expansion port 60 for reception of a plug-in unit 62. In a preferred embodiment of the invention, a plug-in unit 62 is a devise comprising a memory containing digital data representing the motion audio/visual presentation program.

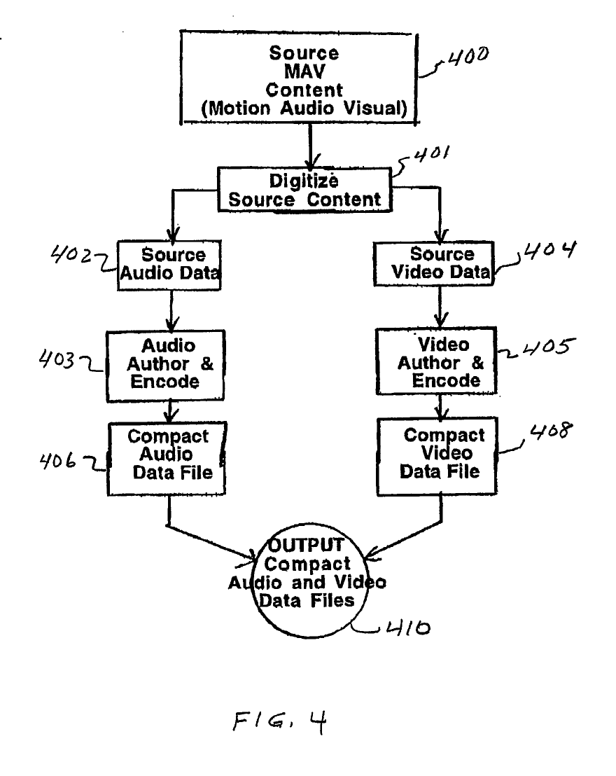

Next referring to FIGS. 3a, 3b, 3c and 3d, there is disclosed therein block diagrams of embodiments of the invention.

FIG. 3a discloses in block diagram form, the plug-in unit for a standard Game Boy Advance 101. The GBA 101 has an expansion slot 104 for receiving the plug-in unit 100. When the plug-in unit 100 is mated with the GBA, the plug-in unit receives power from the GBA through the electrical connection 102. The memory 106 may be a read-only memory or a flash memory integrated circuit (IC) device, which contains all of the compressed video and audio digital data program 108, as well as the program instructions and data 110 for the player control program 112. The compressed video and audio digital data program 108, program instructions and data 110 and player control program 112 have different address spaces within the memory 106 and are depicted in FIG. 3a as separate boxes within memory 106. The digital data 108 and 110 and player control program 112 are connected to the GBA 101 by means of electrical connections 114, 116, and 118, respectively. Electrical connections 114, 116 and 118 are the address bus, multiplexed data and address bus and control bus, respectively. It will be understood that electrical connections 114, 116, and 118 may be multiple, independent electrical connectors and that the representation of one line in the Figure should not be interpreted as limiting the electrical connections to one conductor. This notation is commonly used in schematic to represent a bus, a collection or group of similar signal lines, such as a data bus, or control line bus.

Next referring to FIG. 3b, there is disclosed another embodiment of the invention wherein a plug-in memory 130 has a non-multiplexed ROM IC 136 and data latch circuit 133. The plug-in memory 130 is utilized with a personal digital assistant (PDA) 132 or portable game playing unit such as GBA, having an internal memory 137 and ROM IC device 134. The ROM IC device 134 contains the instructions to operate the PDA or portable game playing unit. The plug-in memory unit 130, personal digital assistant 132 (or portable game playing unit) and the aforesaid devices are electrically connected by means of bus 135. In this embodiment, data latches 133 are used to demultiplex the expansion bus signals through bus 135 so that a non-multiplexed ROM IC 136 can be used directly. It will be understood that other embodiments of a PDA design may also be utilized.

A ROM IC device 134 on the PDA or portable game playing unit such as GBA, may contain data and instructions to operate the audio/visual player program so that the ROM 136 need only store video and audio data. Alternatively, the ROM IC device 134 could store all or some of the video, audio and control program data.

Referring next to FIG. 3c, there is shown therein a block diagram of another embodiment of my invention, wherein a “booster” card 150 is capable of interconnection and mating with the expansion port of a personal video game 152, such as a Game Boy Color (GBC) or a GBA. The booster card 150 augments the processing power of the personal video game. In a preferred embodiment, a plug-in unit 100 having a memory 106 as described above may be connected to the booster card 150.

The booster card 150 comprises electronic subsystems that can electronically engage with the electric portion of the personal video game 152. Some personal video games do not contain sufficient processing power to operate the decoding of video and audio data, but do contain a color video display screen 156, an expansion port 158, control switches 160 and 161, and an audio speaker 162. The processing power of the CPU in the personal video game 152 unit is required to operate the program instructions to decode compressed video and audio program data and to operate at a sufficiently fast speed to maintain the flow of video and audio at various frame rates from 1 to 50 frames per second

It will be understood that, in addition to ROM read-only memories, the memory chip discussed above could also be a memory write once, read mostly (WORM) such as a flash memory. The memory device may also be mask programmed once during manufacture at the factory, or it can be electrically reprogrammed numerous times with new data, such as flash memory or other types of non-volatile read/write memory.

For personal video games 152 that do not have sufficient processing power for embodiments of the invention which interface with various memory storage media, such as audio CD players, audio players, telephone lines, or various low speed communication signal lines, a booster card 150 is provided to provide the processing power required to decompress the audio video data at a sufficient speed to obtain acceptable playback of the program on the video screen.

An embodiment of a booster card is disclosed in block diagram form in FIG. 3c. The booster card 150 comprises a central processing unit 200, RAM data buffer 210, program data storage memory 220, operating program data storage 230, control logic circuits 240, power supply 250, memory devices and control logic 260. An optional dual A/D (analog-to-digital) converter 270 operably connected to the bus 280 is provided for situations when the video data is encoded in the analog signal by various modulation methods such as FM, Phase Modulation, PCM, or other modulation methods. This may occur when the memory storage device is a CD player, audio tape, cassette player, telephone line, etc.

The RAM data buffer 210 is operably connected to the control logic circuit 260 and the stored program 220. The operating program data storage memory 230 stores the operating instructions for the player control program and data for the player program. The logic circuit 240 is operably connected to the CPU and memory storage units.

FIG. 3d discloses in block diagram form an alternative embodiment of a booster card 300. A first in/first out (FIFO) memory 310 is operably connected within the booster card 300 for buffering video and audio data output or data received from the plug-in content memory device 312. An audio output circuit 314 such as a pulse width modulator circuit or a digital-to-analog converter and power amplifier 318 for producing audio signals for the loud speaker in the audio/video player unit such as a personal video game or audio headphones electrically connected to the audio/video player in monophonic or stereo audio format.

An optional power supply 324 is used to power the various circuits. The power supply 324 (in this and the other embodiments of the invention) may be by means of batteries or an adaptor capable of converting a conventional A-C household voltage to a voltage level suitable for operating the circuits of the booster card. Alternatively, the booster card may obtain its powder from the PVG through the expansion port and connector plug.

In cartoon animation such as the anime style, which is popular in Japanese and American television shows for children and certain feature film programs for children, a distinct visual type of video representation is present which is different from other kinds of visual programs, such as sports events, westerns, or performances with live actors and the like. This anime style is susceptible of certain types of video encoding and decoding methods. Anime style has many attributes, which make it susceptible to higher digital data compression ratios as compared to other kinds of motion audio/video content. For example, the anime cell animation style of painting color onto an acetate or mylar sheet for each frame of animation generally employs only a limited number of colors. Also, the colors tend to be large flat areas of the image. Additionally, the background in the image often does not change for many frames of animation.

The anime animation rate is usually 24 frames per second, rather than the 30 frames per second utilized for NTSC video, thus permitting additional data compression because of the lower frame rate.

Additional data compression is also possible because the viewing screen of the invention will be relatively small in size (for example, in a preferred embodiment, two inches by three inches). Since the viewing screen is relatively small, much smaller image resolution is required and thus a smaller image data set is required. Additionally, because of the limited color utilized, use of a color look up table sometimes known as “indexed color” will result in additional reduced data size.

For example, in analyzing color style animation, less than 256 colors are generally present in any given frame or series of frames. Assuming that a screen has a resolution of 200×100 pixels (i.e., 20,000 pixels), and operates on a 16 bit RGB color model per pixel of color, the memory required to hold one frame of color data is 40,000 bytes (20,000 pixels×16 bits/pixel×1 byte/8 bits). By using “index color” compression, one of the 256 color lookup values can be stored per pixel, so only 20,000 bites of memory would be required to store a frame of video, plus a 256 element color lookup table which stores 16 bits per color (i.e., 512 bytes). Accordingly, if a color pallet table is updated, for example, every four frames for a playback rate of 15 frames per second, the memory required to store the frames of video would be approximately 50% less than the direct color method without “index color” compression.

The invention also utilizes subjective aspects of psychovisual and psychoaccoustical perceptions. A human will accept a large amount of perceived loss of quality or distortion in a reconstructed video or audio presentation if the video screen is reduced in size because the loss of quality or distortion will become less perceptable as the screen is reduced in size.

Now I will discuss the methods and processes by which the digital data of a motion audio/visual (MAV) file may be compressed to reduce the file size. The unique and novel aspects of this embodiment of the invention will be appreciated by those having ordinary skill in the art. The invention is particularly suited for compressing the digital data representations of the audio/visual content of cartoons, animations, and other audio/visual time variant content into a very small and compact amount of memory, either as digital data or (if desired) in analog memory form.

The invention does not utilize methods for compression or other similar techniques commonly known as MPEG-2, MPEG-4, motion JPEG and other similar methods for compressing time variant audio/visual program content. They are generally known as content independent compression methods. These methods are similar in that they operate without regard to the nature of the content. These content independent compression methods must be utilizable with a full spectrum of motion audio visual (“MAV”) content. However, the embodiment of the invention herein described is directed in part to specific content and this content specific compression is a method which is optimized for certain types of content such as animated cartoons and other content material which have the unique characteristic of visual elements as described further below, but may also be utilized with other types of MAV content. The invention lends itself to achieving much higher compression rates compared to the content independent compression methods presently known and utilized. This is sometimes referred to as Content Dependent Compression.

One of the features of the invention is to provide audio and visual quality, which is of sufficiently high quality that it will be acceptable to children and entertain children in the telling of the story of the cartoon, movie, video or other MAV program content.

The invention takes advantage of the fact that the senses of hearing and listening, as well as the visual perception of children are less well developed and refined than those of older persons. Additionally, the fact that a child is physically smaller than a full grown adult causes a child to perceive a one or two inch square video display screen as much larger relatively than it would be perceived by an adult.

Since the video player described in detail above, utilizes a relatively small video display screen or imaging device rather than a large screen television display, the invention utilizes aspects of the psycho-visual perception of children to remove and reduce visual details which are below a certain threshold of perception. Additionally, because in many cases, much of the story line and continuity of an animated cartoon program is carried by the audio portions of the program, i.e., the voices, music and sound effects, lower video quality is acceptable to children in viewing the program, provided that the audio quality is sufficiently good enough for the child to hear and perceive the words spoken by the character, the music and sound effects. Also of importance is the temporal synchronization of the audio elements, i.e., the voices of the characters, the music and sound effects, to the visual motion picture.

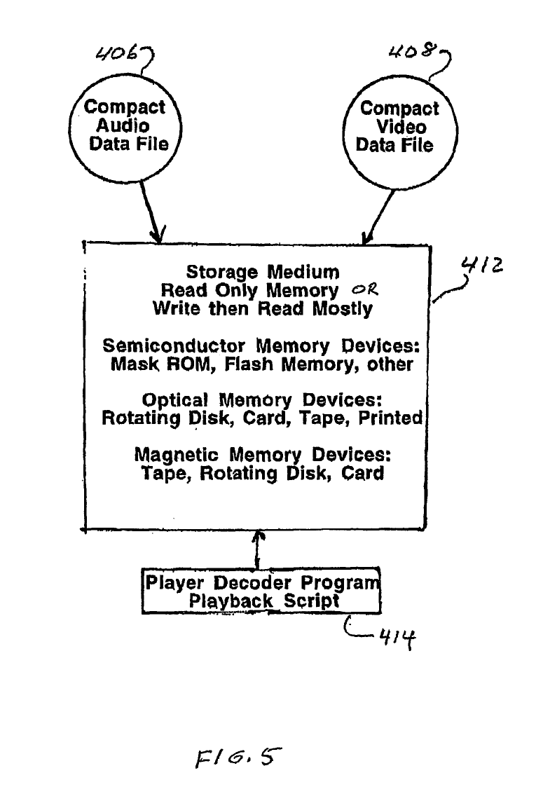

Referring now to FIG. 4, there is disclosed a general flow chart for a highly asymmetric encoding process and decoding process (CODEC) for audio and motion visual content. Because the encoding is only performed one time, it is of great advantage to utilize extensive data processing and mathematical techniques in the encoding process, which will minimize the time and hardware requirements in the decoding process. Because the encoding is only performed one time, and the decoding will be performed many times, the asymmetric nature of the process is not only acceptable, but desirable. This process allows the invention to utilize relatively low performance computational devices in the playback device, which may, accordingly, be of a lower cost.

In the encoding of the audio and video data, a large amount of time and computational power and processes are applied to process the source, motion, audio and video (MAV) information and reduce it to a very small memory size. Therefore, the computational processing required to decode and transform the compressed audio and video data files back into usable audio and visual playback is greatly reduced. Also of importance is the temporal synchronization of the audio elements, i.e., the voices of the characters, the music and sound effects, to the visual motion picture.

The flow chart of FIG. 4 shows the basic overall process of the encoding method.

As those having ordinary skill in the art will appreciate, a typical NTSC color video program of approximately 22 minutes, when converted to digital data, will require tens of gigabytes of memory to store the program. A typical spatial resolution of an image of such a program is 650 pixels×480 pixels. The results are 307,200 pixels per frame. Assuming a rate of display of 30 frames per second, the memory required to store one second of such digital data in an uncompressed format must be sufficient to accommodate 9.36 mega pixels. Assuming a full color representation of 8 bits per red, green and blue pixel (one byte per color), the amount of digital information is over 27 megabytes of digital data per second.

Additionally, digital stereo audio generally has a sample rate of 44 KHz and assuming 16 bits per sample, each minute of digital audio requires over 8 megabytes of digital audio data.

The invention in a preferred embodiment allows digital data to be greatly compressed. The video player described above such as a GBA may utilize a screen of approximately two inches×2 inches. This screen size may have a resolution of 240×180 color LCD video display. It may have in this example, an 8 bit PWM stereo audio output system. Technical details and information about the GBA can be found on numerous websites on the internet, including, but not limited to, www.gamegizmo.com/afterburnerkit.html. Such GBA information may also be obtained from Nintendo Corporation, manufacturer of the GBA. The GBA technical information is owned by Nintendo Corporation and access to its detailed technical information may require a license. It will be understood from those skilled in the art that the compression process described below can be applied to data to be processed and played on a GBA as well as other devices.

It will be understood by those skilled in the art that the process described below utilizes certain traditional compression methods. However, the invention introduces new compression methods and the specific process combination or specific process sequence of application of each element of the compression, in combination and separately, are unique and novel.

Referring first to the audio encoding process, the Motion Audio Visual Content (“MAV”) 400 is digitized 401. The digitized source content 401 comprises digitized audio data 402 and digitized video data 404 undergo separate compression processes. However, it will be appreciated by those skilled in the art that the compression processes may be simultaneous. The digitized source audio data 402 is encoded 403 and the digital source video data 404 is also encoded 405. The encoded digital audio data 402 is encoded into compressed audio data file 406 and the encoded digitized video data 404, after encoding, becomes a compressed video data file 408. These two compressed digital data files 406 and 408 are then transferred to a single large read only memory data file 410.

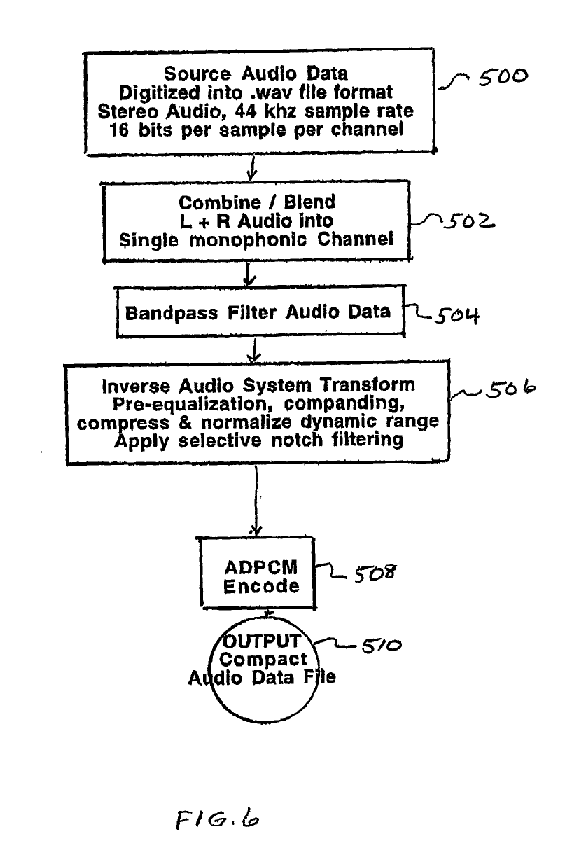

Referring now to FIG. 5, the compressed audio and video files 406 and 408 are stored in a memory storage medium 412, along with the player decoder program 414. It should be noted that in the discussion and figures, the terms compressed and compact are used interchangeably.

The player decoder program 414 runs and controls, in part, the target video player circuit system. The player decoder program 414 is the object code of instructions for the central processing unit of the video player system, which enables the video player system to take the compressed data files, decode them, and convert them into output information as sounds and video display. The player decoder program 414 also includes all the control and programming for operating the video player, reading the status of the controls, such as push button switches, performing play/pause, rewind, fast forward, and other user controls. It also presents the time and title information on the screen, as well as other related graphic user interface (GUI) elements. A person having ordinary skill in the art of programming such devices can readily write such a player decoder program for such a video player.

Such video player devices such as GBA are not normally used as MAV playback devices, but because of the unique process of the invention, even devices such as GBA, which have limited processing power are able to play the MAV. As will be appreciated by those having ordinary skill in the art, the invention may be implemented on many such devices.

Referring again to FIG. 5, there is shown the formation of the memory medium 412, whereby the compact audio data file 406, compact video data file 408, and player decoder program playback script 414 are stored on the memory storage medium 412. As will be appreciated by those having ordinary skill in the art, the medium may be a semi-conductor memory device, may be a mask programmed, non-volatile, read only memory (ROM) or an electrically programmable, non-volatile writable and readable memory (“WRM”) such as Flash memory or other similar non-volatile memory, an optical memory device, such as a rotating disk, card, tape, or a magnetic memory device, such as a tape, rotating disk, or card.

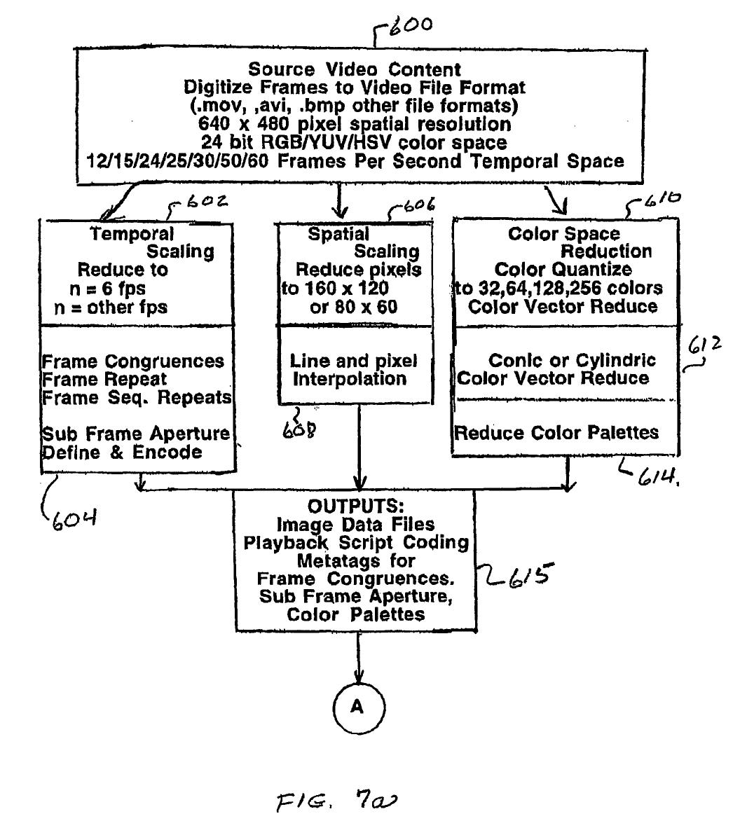

Next referring to FIG. 6, the source audio data 500 is digitized typically into a WAV format audio file. Typically, the digitization has a 44 KHz sample rate, 16 bits per sample, and is stereophonic (i.e., it has left and right channels) source audio. The digital audio results in approximately 1.408 megabits per second of data. The purpose of the audio encoding is to maintain the best reproduced audio quality on the video player, while obtaining the lowest effective data bit rate possible, which will result in acceptable audio quality.

The audio encoding process includes an optional stereophonic to monophonic conversion 502 which will reduce the audio digital data file size by a factor of two.

Next, the audio data is processed digitally through a band pass audio filter 504 to cut out any audio information and energy below a predetermined frequency (FL) and any audio information or energy above a predetermined frequency (FH). The purpose of this band pass filtering 504 is to reduce the audio data further, prevent antialiasing of the data compression later using pulse code modulation (PCM) due to the Shannon sampling theorem.

Various other processing 506 of the audio data is implemented, including preequalization of certain frequency bands in the audio, compressing the dynamic range of the maximum and minimum audio volume levels and implementing notch filtering at various specific frequencies to compensate for the final audio output circuit of the video player. This step 506 acts in part as a compensation for the inverse transform of the entire audio codec on the video player, so as to generate the best sounding audio.

The invention may be utilized by means of a video player having an output system, which is not linear, i.e., class A, AB, or B type amplifier. Rather, it may be implemented by means of a class D amplifier based on a PWM circuit. The sampling frequency of the PWM circuit must be carefully chosen and the preequalization and notch filtering of the audio encoding process selected to match the PWM audio output frequency to minimize hiss, noise and distortion.

The audio data is then processed by means of ADPCM encoding 508 to further reduce the amount of data. It will be appreciated by those skilled in the art that there are many PCM and ADPCM algorithms in the public domain, which are known. Careful choices must be made so that the corresponding decoder program can operate fast enough and with minimal central processing unit processing time of the video player and decoder.

The data thereupon is the compressed audio data file 510, which is then transferred to the storage medium 412 in FIG. 5.

Next, the video encoding process will be described.

As will be understood, some of the novel and new visual data encoding processes, such as frame congruence and sub-frame aperture encoding (“SFAE”), which are described below, are particularly related to the content dependent nature of the program. Additionally, some of the other encoding processes are well known to those having ordinary skill in the art, but the manner in which they are implemented and combined in the invention is unique and novel.

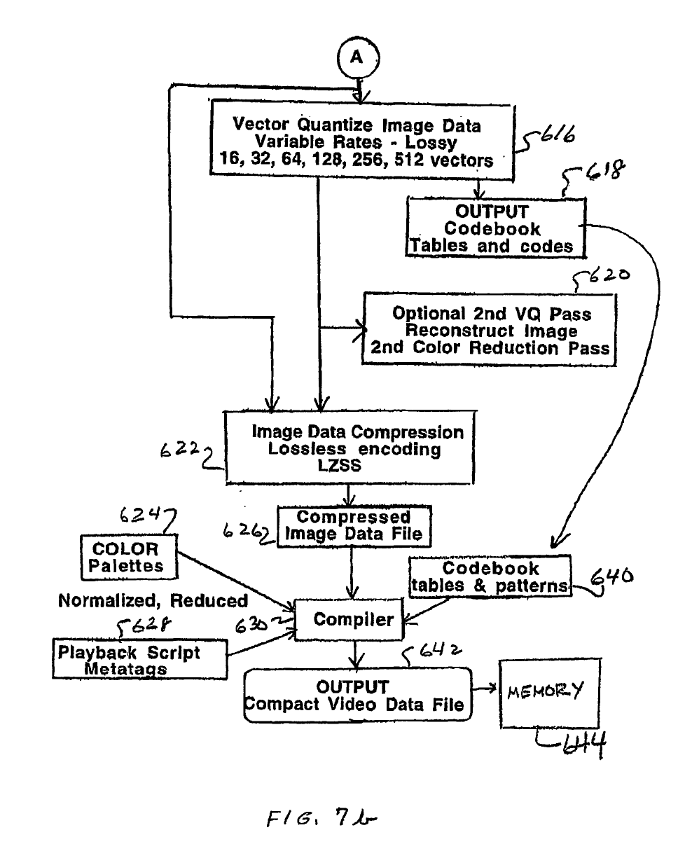

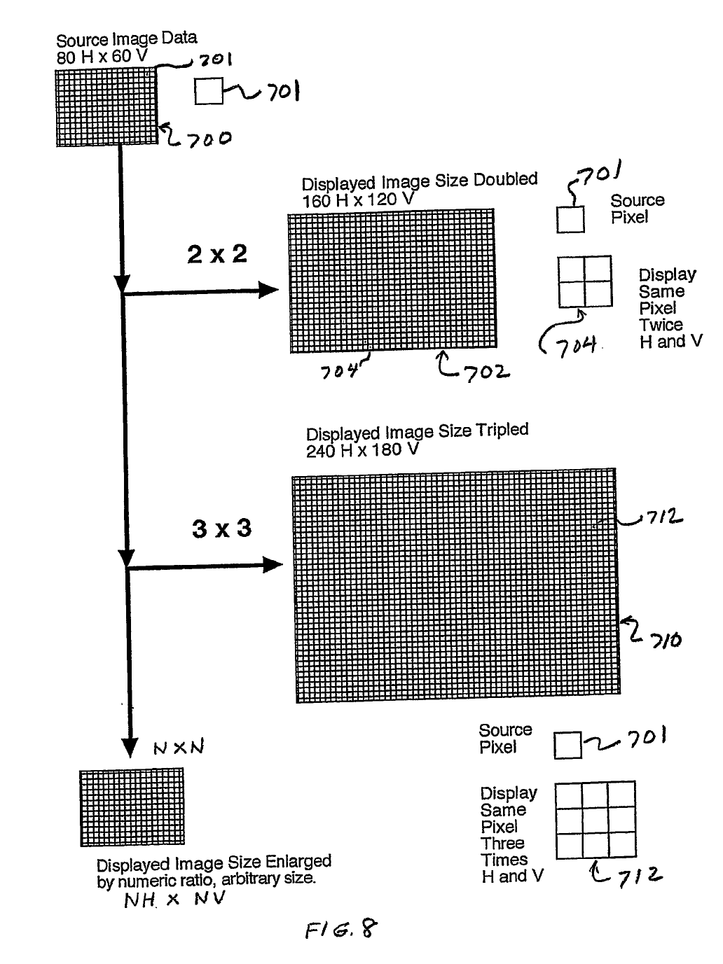

Referring to FIGS. 7a and 7b, it will be understood that point A in FIGS. 7a and 7b represent the same point in the figures. The incoming program source content video is digitized 600. It will be understood that this source content can originate in any type of format. Generally, however, this uncompressed source video has been digitized to a spatial resolution of 640×480 pixels, 320×240 pixels or some other size. Color is represented as full 24 bit color, that is, one byte (8 bits) per red, green, and blue color values per pixel. Color can also be represented in the YUV (luminance, color difference (two)) and HSV (hue, saturation and value) representation. These are known to those skilled in the art and are linear algebraic transforms of RGB values.

The temporal sampling of the digital video is typically 30 frames per second or, as is well known in the art, other film rates such as 60, 50, 25, 24 frames per second or other rates may be utilized with the invention.

The encoding process in its preferred embodiment includes the step of scaling down or reducing the number of frames per second 602. In one preferred embodiment of the invention, the number of frames per second was reduced to 6 FPS.

The steps of frame congruence, repeated frames and frame sequences analysis, and marking and metataging is then performed 604.

The frame congruence step is particularly efficient with an animated cartoon in which there are many occurrences of identical or nearly identical image frames. This is part of the content specific compression process. Frame congruence pertains to the sequences of animation in which none or only a very few or small percentage of pixels in the entire image area are changing on a time variant basis. Each of the frames is marked in the encoding process with a metatag. The playback player video decoder can use the metatags to point back to the source frame, also known as a key frame. Thus, the data for the reoccurrence of the same or substantially similar frames need only be stored one time in the compact video data file. The metatag pointer is a number that points to the source frame data address. Since the subsequent substantially identical frame may be a large amount of digital video data, replacing it with a pointer reduces the video data memory size by a large factor. All the repeated frames are marked with the metatag pointer to the key frame.

Additionally, quantification of the difference between successive frames may be accomplished and when the difference is less than a predetermined level, i.e., there is only a small number of pixels different in successive frames, in small regions or colors. One source frame can be used to represent a successive frame or frames, thus resulting in a very large data reduction.

Quantification of the difference between successive frames may be determined and when only a small portion of the image is changing, such changes may not be generally noticeable on a small video display by the viewer. In such situations, the differences between successive frame or frames are considered negliable and the source frame may be repeated.

The frames and ranges of frames can be manually identified in the authoring encoding process as a guide in the congruence analysis and metatag process.

Also, for example, in animated cartoons, there are many occurrences of repeated frames of sequences such as A+B, A+B+C, and A+B+C+D. Such repeated frames could represent animated characters running against a scrolling or panning background, mouths moving on animated characters, explosions, water flowing, smoke billowing, or many other types of scenes. The process of frame congruence in such situations results in a significant video data reduction.

I will next refer to sub-frame aperture encoding 604, which will be discussed herein below.

Sub-frame aperture encoding results in significant video data reduction and is highly effective for certain content, such as animated cartoons. There are many instances where these are sequences of large numbers of frames, but within each frame only a small portion of all the pixels are changing. In sub-frame aperture encoding, the video data is analyzed and the process comprises the comparison of pixel data from frame to frame and/or mathematical operations such as subtraction of respective pixel values between frames, differentiation, first and second derivatives, and time of pixels per frame, exclusive OR logic operation of sequences of pixels and other processes.

In sub-frame aperture encoding, successive frames are compared, for example, frames N, N+1, and N+2. Frame N is then compared to N+1. This may be accomplished in many ways. For example, each of the pixels in frame 1 may be subtracted from each of the respective pixels in frame N+1. The result will be that the pixels which do not changes from frame N to frame N+1 will have zero values. However, there may be a limited area indicating a change. For example, there may be a small region, which has changing values. The boundaries of this region may be computed by convergence. This region is known as the sub-frame aperture region. Only the digital data for this sub-frame aperture region need be stored as the other video information for frame N+1 has not changed from frame N. Similarly, frame N+2 may be compared with frame N and the results may be similarly utilized.

The position of the sub-frame aperture and its size are marked and stored in the metatags for the video player script language.

By way of example, and not by way of limitation, if there are frames N, N+1 and N+2 with each frame having Q pixels and the difference is between frame N and N+1 and between frame N and N+2, are each approximately 5% of the total screen area, instead of storing three full frames of pixels per frame (i.e., 3 Q pixels), only the first frame and the sub-frame aperture regions of frame N+1 and N+2 need be stored. This results in 1.1 Q pixels of stored data, significantly less than the original amount of data.

I have found that in a typical cartoon show, use of sub frame aperture encoding results in very significant video data size reductions.

The encoded data from the frame congruence and sub frame aperture encoding processes are in a form of the playback script and metatags. These all reference the image frame data files. These are also used in the final video image data compiler to reduce the actual data stored in the compact video data file output.

Another step in the video encoding processing is to reduce the spatial size in pixels 606. For example, the spatial size may be reduced to 160×120 or 80×60 pixel sizes. The spatial scaling is performed by image processing algorithms, such as those found in many commercial software image programs, such as Photoshop and Premier from Adobe Software Company, for example. This process further reduces the data size by factors of (for example) 4:1, 8:1, and more.

The spatial scaling includes interpolation of lines and pixels 608 in reducing the total number of pixels. It is best performed at the full resolution as source input and with full color information for each pixel present.

It must be noted that the encoding process is capable of allowing for the sequence of time and spatial scaling to be reversed. That is, it is possible to first implement the time scaling technique and to subsequently implement the spatial scaling technique and then perform the frame congruence processes. Line and pixel interpolation 608 are then performed on the scaled video data to improve image quality.

Color space reduction 610, conic or cylindric color vector reduction 612 and reduction of color pallettes 614 may also be accomplished. As will be understood, the source material may contain over 16 million color representations when 24 bit RGB color is utilized. The invention is capable of greatly reducing the number of colors required to reconstruct the final playback image. Contents such as animated cartoons use very few colors. The color regions tend to be painted, either with pigment on acetated cells or by computer graphics paint programs. However, the color reduction methods of the invention disclosed herein, can be applied to non-cartoon motion visual content as well, and can produce visually acceptable quality.

While a preferred embodiment of the invention is optimized for cartoon and animation style visual content, the invention is not necessarily limited to the such applications or to animated cartoons.

The visual quality of the color reduction on photographic type images may in fact present a tolerable and compelling result which is of sufficiently high quality for the toy and game player systems on which it is used. For example, in wireless cellular telephones with color video cameras and small, color video screens, even a small, limited color image of a face of a family member, friend, or loved one, or even a pet, can still provide an entertaining experience of value, despite the low quality of the visual image.

Color quantizing 610 is applied to reduce the colors, such that colors within the RGB, YUV or HSV color space are reduced to a small number of common colors. Color vectors can be defined to specific limited sets of colors. Color reduction takes any color vectors within a predetermined distance of the specific set of colors and assigns them to one vector or color. Color may also be normalized such that the number of shades of a specific hue may be reduced such that only the reduced set of hues are represented in the compressed video data.

In some frames, color may be represented by an indexed color, rather than direct color. This results in color palette sets, which are indexed by represented numbers known as the index values.

For later use of the LZSS lossless image data compressor (discussed below), which is used in the encoding process, each frame normally carries a separate palette. One aspect of the invention is to eliminate or greatly reduce the need for a separate color palette for each frame. The many palettes are normalized and reduced to a much smaller set of common palettes, which provide a close match to the actual colors. For example, a token pointer to one of 256 palettes, can replace the 512 bytes of palette data with one byte, referencing a single 513 byte palette set.

It is possible to reduce the data size of the color pallets 614. For example, an uncompressed 80×60 pixel image using 8 bit index color, requires 4,800 bytes of image data storage, plus 512 bytes of pallet data (256 index values×16 bits per color index entry). The pallet data is over 10% of the image data size (4,800 plus 512=5,312 bytes). Ten frames of uncompressed color data will require 53,120 bytes. If the frames are reduced by the use of one common pallet, 5,120−512=4,680 bytes are saved, or almost 10% of the size of the ten frames. In practice, it has been determined that using reduced color pallets of 64, 32, or even as few as 16 colors for various frame sequence groups of tens or hundreds of frames can result in 2:1, 4:1, 8:1 or greater color data reductions.

The outputs from the color data reduction include pallets of colors, common pallets, and color pallet metatags 624. This information is passed to the final video data compiler 630 and is stored in the compact video data output file 642 for use by the decoder and playback device.

The video compression process also utilizes conic and cylindrical color vector quantization 612.

In the color space cube, be it RGB, YUV, or HSV color space, and for the content dependent process of my encoding, these color vector reductions produce very acceptable image quality.

In conic color reduction 612, a variable difference angle in radians, in vector magnitude, is set scene by scene, either automatically or by semi-automatic procedure of a human authoring encoding operator to reduce the colors to the minimal possible, while still maintaining acceptable image quality.

In cylindrical color reduction 612, a similar process in the color space cube is performed, but with a radius instead of an angle representing the difference between scenes.

It should be understood that sub frame aperture encoding can be applied to the image data files at this step in the digital video encoding process. With reduced color space, the frame congruence process will often result in additional data savings.

It will also be understood that the sequence of applying the processes to this point are permutable, based on obtaining the greatest data reduction, while maintaining the best picture quality possible. It is also possible to perform the various data reduction techniques again to reduce the size of the data set, provided acceptable video quality is maintained.

Also, color quantizing down from 5 bits per color element to 4 or 3 bits per color element can be utilized, alone or in combination with the color vector reductions.

The encoding process may be run on a personal computer system to analyze and compute the data sizes as each step is implemented. Also, a display in a small video window on the PC video screen, playback of the encoding image data, the difference data, and a simulation of the decoder process for visual quality monitoring may also be displayed. All of the process variables, the differences and tolerable error factors can be varied manually by the authoring and encoding operator to measure the best combination of video data reduction and image quality. Lists and displays of the metatag parameters, the playback scripts, and all other parameters are also available for inspection, printout, and recording in data files during the process.

The outputs 615 of the various encoding steps comprise image data files, playback script coding, metatags for frame congruences, sub-frame aperature and color pallettes.

The next step in the encoding process is vector quantizing of the image data 616. Vector quantizing is a well-known public domain mathematical image data processing technique. In this technique, small regions of pixels are compared to a set of common pixel patterns referenced by a look up table, also known as a codebook table. Depending on the number of vectors supported, various degrees of image quality loss in resolution, details, smoothness of colors and other visual degradations can occur. Vectors may range in size from 30 to 512, but vectors outside this range may also be utilized. The step of vector quantizing is content dependent and is optional.

The use of variable levels of vector quantization is highly advantageous to reduce the total video data size in certain content dependent video data such as cartoon animation images. Depending on the visual elements of a scene, the animation levels, and the like, some scenes can be subjected to vector quantization, and still produce an acceptable image quality. The outputs of the vector quantization are codebook tables and the code patterns 618, and the reduced image data set.

The LZSS data reduction technique 622 for color images is well known to those having ordinary skill in the art. It is utilized in an embodiment of the invention. It is applied as a final step in the process, either after the vector quantization process, or in some cases, when vector quantization is not utilized, after the techniques discussed above.

LZSS is a lossless compression process so it is preferable compared to vector quantization, which is lossy. LZSS has the advantage that the decoder for LZSS is a fast computing process and can be implemented in a video player having a relatively low amount of CPU processing capability.

Because the earlier process of color reduction works in tandem with LZSS to reduce the number of color pallets, there is a link of data from the color reduction stage to the LZSS stage.

Additional data reduction can be obtained on certain types of content scenes by repeating the vector quantization 620 process a second time. This is done by having the vector quantized image reconstructed in a frame buffer and then color reduced a second time prior to the final LZSS compression of the data.

The compressed image data file 626 is then compiled 630 along with the color pallets 624, which may be normalized and reduced, the playback script metatags 628 and the codebook tables and patterns 640. The compiled data then comprises the compact video data file 642. The compact video data file may then be stored in a memory 644 which may be of the types described above for use in the audio/video player or other display device mentioned above.

The decoding of the encoded data is basically a reversal of the previously disclosed processes, that is, to decode the encoded data, the encoding process is essentially performed in reverse. One having ordinary skill in the art is fully capable of writing the actual computational program instructions for the decoding process. The use of codebook lookup tables in the computational decoding process of playback is quick with minimal CPU capacity required.

The decoding of the ADPCM compressed audio data may utilize an intermediate buffer in which the reconstructed PCM samples are stored for playback by the audio output hardware circuits. In one preferred embodiment using the GBA, the audio output circuit utilizes PWM to drive an audio loudspeaker or audio headphones. The sample rate of the PWM circuit can be adjusted to one of several rates, so the ADPCM decoder may be optimized for one or more of the PWM rates.

The above-described preprocessing of the audio signal data optimizes the reverse transform of the audio output system characteristics to provide optimum audio quality at low bit rates. In the case of using only monophonic audio data, the audio data may still be utilized in the left and right channels of a stereophonic audio output device, such as audio headphones. A slight delay of 1-50 milliseconds between the left and right channels may be implemented. It has been found that this produces a slight echo or reverberation audio sensation. This makes the audio sound more “open” or full sounding due to psycho-acoustic perceptions.

It has also been found that keeping the audio sounds “in sync” with the video pictures is very important. A controlled synchronizer which is based on metatags and key frame video and audio matching may be implemented to maintain synchronization within plus/minus ten milliseconds.

When the player is put into a pause/resume mode, or when using chapter sync features, or when using single step frame plus/minus, it is necessary to resync the audio to the video at these points when play is resumed. The metatags assist in synchronizing the audio and the video positions.

The highly compressed and processed video data file and the playbacks script control are utilized in the video player decoder operation. The playback script (PBS) is used to decompile the instances of frame congruence, repeated frames, and frame repeat sequences, as well as the sub frame decoding. The PBS also controls the application of the various video data decoding processes on a screen-by-screen or a frame-by-frame bases.

Variable rate encoding may be used, for example, if vector quantization has been used on a scene, the level of vector quantization, the codebook for that level, and the lookup tables and color pallets to be used are all guided by the PBS.

The reversal of LZSS compression on the compact video data is the first step in the player decoding process. This data is placed into a temporary memory buffer. Then, for scenes where vector quantization has been used, the code book table lookups are performed. Color pallet data is loaded for scenes into the color lookup tables. A fixed set of pallets is used, so the main loading of pallet sets occurs early in the playback process. Then, only those pallets needed for a scene or a set of scenes need to be loaded to the color video display hardware.

In the case of sub frame decoding, a smaller memory buffer maintains the sub frame aperture region, and the PBS includes the coordinates of the location to place the sub frame video data in the image output video buffer.

Another method for reducing the amount of video data is to replicate or repeat a source pixel a number of times in the video display.

For example, in one embodiment of the invention, the actual video display screen has a resolution of 240×180 pixels. The screen operates at 100 DPI spatial resolution. The core video image reconstructed is an 80×60 pixel image frame. If this size were to be displayed directly, it would only fill a small area of the main display (approximately 0.8×0.6 inch), but the image would appear sharp and clear. By utilizing pixel doubling at a factor of 2×2, the displayed image is increased to 1.6×1.2 inches. The image would thus appear larger on the display screen. At the increased size, the image will appear somewhat less sharp, but will still be quite acceptable in quality.

Referring now to FIG. 8, there is depicted three examples of pixel replication: 2×2, 3×3, and the general case. The examples assume source image data 700 comprising a two-dimensional matrix of 80×60 pixels. For a 2×2 replication, the transformed video comprises a two-dimensional display 702 having a matrix of 160×120 pixels. Each source pixel 701 appears as four identical pixels 704, i.e., twice in the horizontal and twice in the vertical positions.

For a 3×3 replication, the transformed video comprises a two-dimensional display 710 having a matrix of 240×180 pixels. Each source pixel 701 appears as nine identical pixels 712, i.e., a 3×3 square of the source pixel 701.

For the general rule, source image data in a two-dimensional H×V matrix may be enlarged N times by replicating each of the source pixels in the displayed image as a square set of pixels having N pixels on each side of the square set. The dimension of the transformed video display will be NHXNV.

By utilizing pixel doubling, each source image pixel is actually displayed four times on the video display. It will also be appreciated that pixel replication on a 3×3 mode is also possible and in such a mode, each pixel is displayed nine times, 3×3, and the image size displayed will be 2.4×1.8 inches and will fill the entire video screen. Again, the image appearance is reduced in sharpness and clarity, but in the case of content dependent source material, such as cartoon animation, this size will still produce an acceptable image quality.

In one sense, pixel replication is somewhat analogous to a “zoom-like” feature, but the quantity of digital video information between the unzoomed and the zoomed image is identical.

Because the image is moving and changing and the audio portion of the story is clearly heard, it will be understood that the combined psycho-visual and psycho-acoustic perception will still be acceptable in quality to children. By using pixel replication, the video player can produce an acceptable image quality at a larger physical size, based on use of a much smaller video data image size, which results in a large amount of video data memory savings.

The invention may be utilized in the playing of interactive audio/visual games or other activities. Games such as, but not limited to, those dealing with skill in hand-eye coordination, those dealing with teaching and tests of knowledge, and those dealing with entertainment actvities may be played on the audio/visual player. Additionally, the audio/video presentation on the audio/video player may be utilized in or incorporated into game play by the user or users.

1. A method for compressing digitized video data of a plurality of video frames comprising:
storing a digitized data of a reference frame of the digitized video data;
comparing a subsequent frame of the digitized video data with the digitized data of the reference frame;
determining a boundary of a sub aperture area of the subsequent frame of digitized video data which exceeds a predetermined dissimilarity level with the reference frame; and
storing digital information within the boundary of the sub aperture of the subsequent frame which exceeds the predetermined dissimilarity level.

2. The method of claim 1, further comprising:
identifying the reference frame by a reference frame metatag pointer.

3. The method of claim 1, further comprising:
identifying the digital information within the boundary of the sub aperture area of the subsequent frame by a subsequent frame metatag pointer.

4. The method of claim 1, wherein the digitized video data to be compressed is stored in of pixels representing discrete areas of the frames of video data.

5. The method of claim 1, further comprising:
comparing the digitized video data corresponding to a discrete area of the stored reference frame with digitized video data of a corresponding discrete area of the subsequent frame of the digitized video data.

6. An apparatus for playing a compressed audio and video data file corresponding to a prerecorded audio-video program comprising:
a hand-held digital video processing device having a video display screen, an electrical-audio transducer and a central processing unit electrically connected to the video display screen and the electrical-audio transducer for reproducing the video and audio program;
a program storage media containing asymmetrically compressed digitized audio and video information coupled to the central processing unit of the hand-held video processing device for transferring the digitized audio and video information; and
a control storage media containing a decoder program for decoding the compressed digitized audio and video information coupled to the central processing unit for controlling in part the reproduction of the compressed digitized audio and video information.

7. The apparatus of claim 6, further comprising:
a supplemental processing unit capable of assisting and electrically connected to the central processing unit of the hand-held video processing device for assisting the central processing unit with decoding the compressed video and audio data, and wherein the supplemental processing unit is in a separate enclosure from the hand-held video processing device and is removeably coupled to the held-held video processing device without damaging the hand-held video processing device.

8. The apparatus of claim 6, wherein the hand-held video processing device is an electronic video game playing unit.

9. The apparatus of claim 6, wherein the compressed digitized video information comprises cartoon video representations.

10. The apparatus of claim 6, wherein the central processing unit synchronizes decoded digitized audio and video information.

11. The apparatus of claim 6, wherein the compressed digitized video information is compressed at least in part in accordance with the method of claim 1.

12. A method for compressing digitized audio and moving video information comprising a plurality of frames of data, the method comprising:
separating the digitized audio and moving video information into digitized audio information and digitized video information.
reducing the frequency range of the digitized audio information by filtering out substantially all of the audio data above a predetermine first frequency and filtering out substantially all of the audio data below a predetermined second frequency to form a reduced first audio data set;
performing an ADPCM encoding process on the reduced first audio data set to form a reduced second audio data set;
storing the reduced second audio data set in a first memory;
reducing the number of frames of moving video information;
comparing a first reference frame of video data with a subsequent first frame of video data;
quantifying difference between the first reference frame of video data and the subsequent first frame of video data;
applying a first metatag identifier to the first reference frame of video data;
applying a second metatag identifier to the subsequent first frame of video data;
replacing the subsequent first frame of video data with the first metatag identifier when a quantified difference between the first reference frame of video data and the subsequent frame of video data exceeds a predetermined value;
compressing the digitized video information by means of a LZSS process to form a post-LZSS compressed video data file; and
storing the post-LZSS compressed video data file in a second memory.

13. The apparatus of claim 6, wherein a compressed digitized audio and video information comprises at least in part compressed digitized audio and moving video information.

14-15. (canceled)

16. The method of claim 12, further comprising:
spatially scaling the digitized video information.

17. The method of claim 12, further comprising:
quantizing the color information in the digitized video information.

18. The method of claim 12, vector quantizing the digitized video information.

19. The method of claim 18, wherein vector quantizing the digitized video information is performed at least twice.

20. The method of claim 18, wherein compressing the digitized video information by means of an LZSS process is performed after vector quantizing the digitized video information.

21. The method of claim 18, further comprising:
creating output codebook information as part of the vector quantizing step; and
compiling the output codebook information with the post-LZSS compressed video data file.

22. The apparatus of claim 6, wherein the compressed digitized video information comprises motion video representations.

23. The apparatus of claim 6, wherein the control storage medium further comprises a playback program to provide a fast forward and reverse function.

24. The apparatus of claim 22, wherein the fast forward and reverse function operates in one of a continuous method and discrete time increment method, while maintaining audio synchronization.

25. The apparatus of claim 6, wherein the control storage media stores a graphical user interface program to be executed by the central processing unit and displayed by the video display screen.

26. The apparatus of claim 25, wherein the graphical user interface presents a set of options for navigating the audio and video data.

27. The apparatus of claim 10, wherein the central processing unit plays back the decoded audio and video information in one of a fast forward and fast reverse mode in one of a continuous or discrete time increment while maintaining synchronization.

28. The apparatus of claim 27, wherein the central processing unit maintains synchronization of the decoder audio and video information after resumption of playback from one of a fast forward and reverse playback mode.

29. A method comprising:
retrieving audio data and video data in an asymmetrically compressed format from a medium in communication with a portable device;
decompressing the audio data and video data to be displayed through the portable device; and
synchronizing the audio data and video data during playback using corresponding metatags in each of the audio data and video data.

30. The method of claim 29, further comprising:
resynchronizing the audio data and video data after resumption of normal playback speed from one of a fast forward, reverse and paused mode.

31. The method of claim 29, further comprising
displaying a still frame during a pause mode;
resuming playback of the audio data and video data after an interval of time.

32. The apparatus of claim 29, wherein the asymmetrical compression format is content dependent.
